(19) United States
(12) Patent Application Publication
(10) Pub. No.: US 2005/0165654 A1
(43) Pub. Date: Jul. 28, 2005

(54) Method and system for searching and structuring purchase information and conducting purchase transactions

(75) Inventors: Brian J. Westcott, Menlo Park, CA (US); Jeff Bride, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: elnnovate, Inc., Menlo Park, CA (US)

(21) Appl. No.: 10/764,338

(22) Filed: Jan. 22, 2004

(51) Int. Cl. G06F 17/60

(52) U.S. Cl. 705/26

(57) ABSTRACT

An Internet portal allows potential buyers to locate and to communicate directly with suppliers of various goods or services. Potential buyers can conduct a search for suppliers through the Internet portal. The potential buyer then selects from a list of suppliers that have been identified through one or more searches. The buyer can link directly to the website of the selected suppliers. The buyer can then select one or more products displayed on the supplier's web site. Unstructured information relating to the selected products is then converted to structured information and stored in a database. The buyer can transmit requests for information, requests for quotes, and purchase orders directly to suppliers through the Internet portal. Buyers and suppliers can collaborate and negotiate with each other through the Internet portal to reach a final acceptable state for a transaction.

### BACKGROUND OF THE INVENTION

This invention relates to methods and systems for conducting purchasing transactions, and more particularly, to methods and systems for searching and structuring purchase information and conducting purchase transactions through an Internet portal.

Traditionally, suppliers of goods have published catalogs that list the products they offer for sale. Many suppliers publish their products catalogs online so that customers can purchase products through the Internet.

Many companies design complex products that require numerous raw materials and equipment from many suppliers. It can take a substantial amount of time and effort to search through Internet catalogs on numerous suppliers' web sites to find the raw materials needed to manufacture a product.

Therefore, third party web sites have been created that collect information on products from multiple suppliers. Product information from multiple suppliers is published on a third party web site. The product information is copied from the suppliers' catalogs.

Potential buyers can review and select goods and services from multiple suppliers by browsing through a consolidated digital catalog on one third party web site. These third party web sites allow potential buyers to shop for products from multiple suppliers without having to independently identify each supplier and navigate through each supplier's web site.

A third party web site can store suppliers' catalogs in a database. Potential buyers cannot interact or collaborate directly with the supplier, because the product information is in the third party's database. Typically, the suppliers listed on such web sites are pre-determined and are restricted to a known set of participants.

There are several disadvantages to using these third party web sites. For example, a third party web site can only host product information from a limited number of suppliers. Also, the third party database of products has to be updated frequently to maintain the most current information on the products that each supplier is offering for sale.

These third party web sites do not allow buyers to negotiate or to collaborate with suppliers. Therefore, a potential buyer cannot order custom-made goods or services through one of these third party sites. Also, there is no efficient way for a buyer to communicate with suppliers to obtain more information on products for sale or to order custom-made products.

Therefore, it would be desirable to provide systems and methods that allow potential buyers to identify suppliers and to conduct purchase transactions directly with the suppliers through the Internet.

### BRIEF SUMMARY OF THE INVENTION

The present invention provides techniques for identifying suppliers and conducting purchase transactions directly with the suppliers over the Internet. The present invention provides an Internet portal that allows potential buyers to locate and to communicate directly with sellers (i.e., suppliers) of various goods or services.

Potential buyers can conduct a search for suppliers through an Internet portal of the present invention. The search is designed to identify suppliers of particular goods or services. A potential buyer can perform a structured search on a pre-selected group of suppliers. A potential buyer can also perform an unstructured search using an Internet search engine.

The potential buyer then selects from a list of suppliers that have been identified and collected through one or more searches. The present invention can link the buyer directly to the web site of a selected supplier through the portal. Structured forms are displayed to the buyer and the selected suppliers through the portal. The buyer and the selected suppliers can enter data into the structured forms. The data is stored in a database. The data is displayed to the buyer and the selected suppliers to facilitating purchase negotiations.

The buyer can enter requests for information, requests for quotes, and purchase orders. The information is displayed to suppliers through the portal. A supplier can log into the Internet portal and enter data responding to the buyer's requests. The supplier's data is then displayed to the buyer.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 is a flow chart that illustrates a generalized process for locating and collaborating with suppliers according to an embodiment of the present invention;

FIG. 2 is a flow chart that illustrates how information on suppliers is gathered according to various embodiments of the present invention;

FIG. 3A illustrates a split display screen that includes a list of suppliers and the web site of a particular supplier according to an embodiment of the present invention;

FIG. 3B illustrates a generalized depiction of a split display screen that includes a supplier web site and a structured form according to an embodiment of the present invention;

FIG. 4 illustrates a split display screen that includes a request for information to a supplier and a supplier's web site according to an embodiment of the present invention;

FIG. 5 is a flow chart that illustrates a negotiations process between a buyer and a seller according to an embodiment of the present invention;

FIG. 6 is a flow chart that illustrates a more detailed negotiations process between a buyer and a seller according to another embodiment of the present invention;

FIG. 7 is a flow chart that illustrates a negotiation process between a buyer and a seller that includes a materials requirements plan system according to an embodiment of the present invention;

FIG. 8 is a chart that illustrates how buyer and a supplier enter data into fields of structured forms according to the present invention;

FIG. 9 is a diagram of a system that can implement embodiments of the present invention; and

FIG. 10 is a flow chart that illustrates another process for locating and collaborating with suppliers according to an embodiment of the present invention.

### DETAILED DESCRIPTION OF THE INVENTION

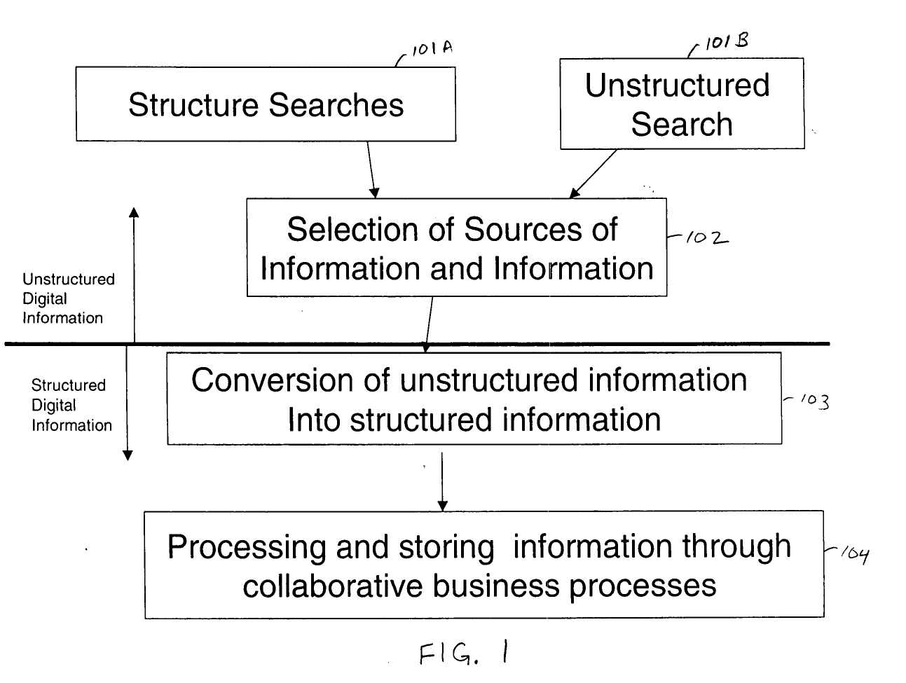

The present invention can provide several different techniques to allow a potential buyer to search for suppliers of particular products or services through an Internet portal. FIG. 1 illustrates a generalized process for locating and collaborating with suppliers according to a particular embodiment of the present invention. Initially, an Internet portal of the present invention allows a potential buyer to conduct a structured search (step 101A) or an unstructured search (step 101B) for a supplier. At step 102, the Internet portal displays sources of information such as a list of suppliers that may carry a desired product and universal resource locator (URL) links to their web sites.

The buyer can select one of the suppliers and link directly to that supplier's web site through the Internet portal of the present invention. The buyer can then locate a desired product on the selected supplier's web site and enter unstructured product data into fields provided by the Internet portal of the present invention. In addition, the present invention offers access to universal registry/repositories that house business artifacts such as company data, product data, and business methodology information. The present invention can convert the unstructured product data into structured product data that is stored into a database and linked to predefined fields at step 103.

The present invention allows the buyer to collaboratively negotiate with a selected supplier through one Internet portal. The Internet portal of the present invention provides a medium for the buyer and the supplier to communicate with each other to negotiate price and terms of purchase. The present invention processes and stores data relating to these negotiations at step 104.

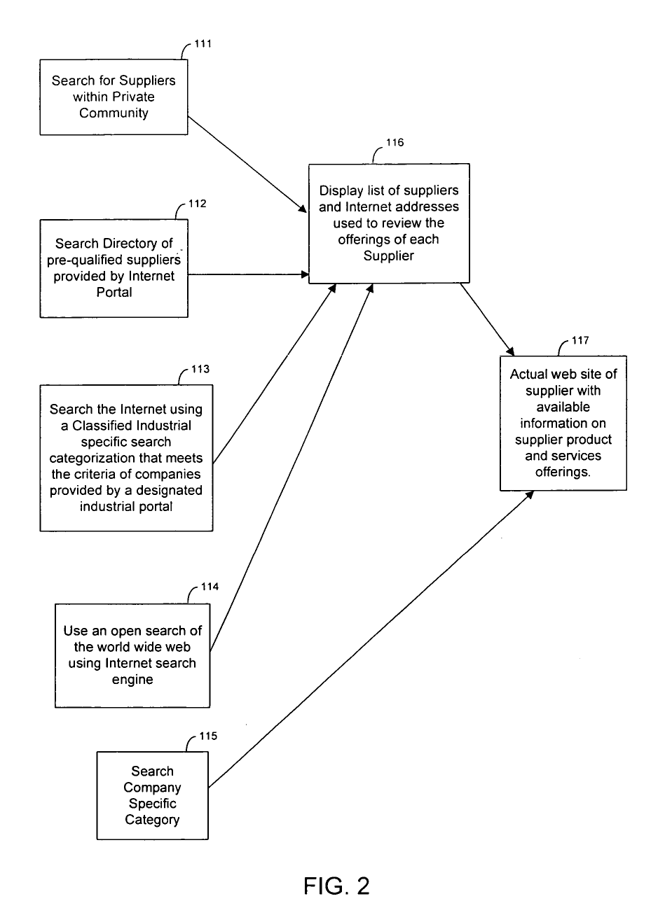

FIG. 2 illustrates several examples of search techniques that can be implemented according to various embodiments of the present invention. A potential buyer can search through an Internet portal of the present invention to locate suppliers that sell goods or services that satisfy the buyer's requirement.

For example, the present invention allows buyers to search for suppliers within a private community at step 111. The private community is set of suppliers that a buyer company typically buys products from. These are suppliers that have met the normal review process of the buyer company and are suppliers that the buyer does business with on a regular basis. For example, an automaker may buy most of the parts for its cars from a private community of 20 suppliers.

An Internet portal of the present invention can generate a search window that allows a buyer to enter search terms. After the buyer enters search terms into the window, the search engine searches through the web sites of the suppliers within the buyer's private community at step 111. Each buyer can have its own pre-selected private community of suppliers. For example, a buyer can create an account with the Internet portal and select preferred suppliers to add to its own private community. The list of preferred suppliers is stored in memory and accessible for subsequent searches at step 111.

The search results of step 111 are displayed to the buyer at step 116. The Internet portal can display a list of the suppliers and their Internet addresses. A summary of each supplier's products can also be displayed at step 116. At step 117, the buyer can link directly to the web site of any of the suppliers displayed at step 116 to review more detailed information on their product and service offerings.

If a buyer does not locate a supplier that offers a desired product or service at step 111, the present invention allows the buyer to search through another set of suppliers at step 112. At step 112, an Internet portal of the present invention allows a user to search through a qualified group of suppliers. This group of suppliers can be members of a community that have been screened or pre-qualified by the Internet portal. The Internet portal groups these suppliers into an online directory. These directories can be subdivided into different industries or by product types. Buyers can search for suppliers in this online directory or a subdirectory thereof at step 112, for example, by entering search terms into a search window. The search results are provided at step 116, and a buyer can link directly to a supplier's web site at step 117.

Buyer companies typically use their established private community (e.g., 25 suppliers) for most of the products they want to purchase (step 111). Buyers may want to receive price quotes from suppliers in a larger community (step 112), such as the portal community (e.g., 2,000 machine shops) for new parts or parts that are very different than parts they have purchased previously.

Both of the search options provided in steps 111 and 112 are structured searches, because they provide buyers with access to lists or directories of pre-selected suppliers. By providing structured searches, a buyer can more easily locate suppliers that produce relevant products, because the suppliers have been pre-qualified by the Internet portal and grouped into industry or product subcategories.

Step 111 is useful, because it searches web sites for a set of suppliers that a buyer has already worked with and trusts. The directory of pre-qualified suppliers provided at step 112 can also be a very valuable resource, because it provides direct links to suppliers of products in particular industries that a buyer may spend a substantial amount of time locating using an unstructured search of the Internet.

If a potential buyer cannot locate a supplier that offers a desired product or service at steps 111 or 112 or wants a total search of available suppliers, the present invention allows the buyer to conduct an unstructured search of the Internet at steps 113-114. At step 113, the present invention searches the Internet using a classified industrial-specific search categorization that meets the criteria of companies provided by a designated industrial portal.

For example, an Internet portal of the present invention can provide a window to a user that allows a user to select a product/service or industry category. The Internet portal then searches the World Wide Web and universal business registries for suppliers in the selected category. The Internet portal can perform this function by searching the Web and the universal business registries using predefined search terms, business classification taxonomy (NAICS, UNSPSC or ISO-3166), or searching through other web sites that list suppliers within particular categories. This type of search is an unstructured Internet search, because it can identify suppliers not previously known to the Internet portal or to the buyer.

An Internet portal of the present invention can also allow a user to conduct a completely open and unstructured search of the World Wide Web at step 114. This search can be conducted through an Internet search engine such as Google™ or Yahoo!™ using search terms selected by the potential buyer. The buyer can then select a supplier at step 116 from a list of suppliers identified in search 113 or 114, and link directly to the selected supplier's web site at step 117.

The advantage of searches 113 and 114 is that they provide buyers with an opportunity to locate many suppliers that are not in the supplier communities searched in steps 111-112. All that is required is that the supplier have a web site or at least be listed on some web site that is accessible through the Internet.

The disadvantage of unstructured searches 113-114 is that suppliers identified through this search have not been pre-qualified or screened. Also, searches 113-114 may identify web sites of entities that do not supply the desired product. Such web sites can turn up in the search results, because the search engines do not limit the searches to a known list of suppliers. For example, the search engine may turn up a web site that mentions a desired product but does not sell it. Therefore, the potential buyer has to expend more effort screening the results of unstructured searches 113-114.

According to another embodiment, an Internet portal of the present invention can allow a buyer to search a company specific category of suppliers at step 115. For example, a copy of a supplier's catalog can be stored in a database for reference and accessed through an Internet portal of the present invention. The copy of the catalog should be synchronized frequently with the supplier's version so that it can remain up-to-date.

According to another embodiment of step 115, the website of a supplier can be a pointer to the supplier's online catalog. When a user clicks on this link, the supplier's online catalog is displayed through the Internet portal as a web page. This techniques does not require that a copy of a supplier's catalog be continuously updated, because the user is linked directly to the supplier's online catalog. For a single supplier site, the only website that a user would be able to see is for that one supplier.

These searches are merely five examples of the types of searches that can be conducted to identify suppliers. The present invention also includes any other type of Internet searches.

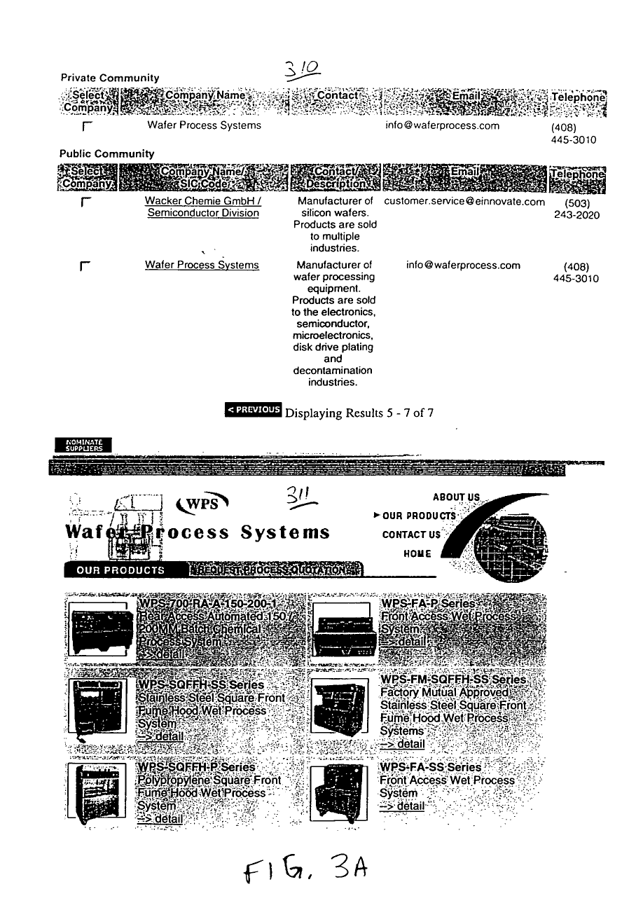

FIG. 3A illustrates an example of how the present invention can display a list of suppliers alongside the web site of a selected supplier according to an example of step 102. FIG. 3A displays a list of suppliers in region 310 that were identified by the present invention during searches conducted at steps 111-115 (or other types of searches). In the example of FIG. 3, one supplier was found in a private community during search 111, and two suppliers were identified in a public community at step 112. The Internet portal displays the names of the suppliers and contact information in region 310. When a buyer selects a supplier name in region 310 (e.g., by clicking on it), the Internet portal displays that company's website in region 311. The buyer can then navigate through the supplier's web site to browse its products listings and online catalogs.

FIG. 3B illustrates an example of converting unstructured information into structured information in step 103 as discussed above with respect to FIG. 1. FIG. 3B illustrates a display screen 300 that can be provided by an Internet portal of the present invention. Screen 300 includes display regions 301 and 302.

Region 301 displays the website of a supplier that a buyer has selected from the list provided in step 102. The supplier's web site shown in region 301 typically contains information on available products and services. The information on a supplier's web site can be in the form of digital catalogs, online brochures, specification sheets, text documents, or other graphic or text based information. A buyer can view this information by navigating through web pages displayed in region 301.

Region 302 of screen 300 displays a structured form. The form contains identified fields that the buyer can fill by cutting and pasting or typing information from a supplier's web site displayed in region 301. The information can be in the form of text or graphical information. Additional non-structured or semi-structured information can be added to the form by a buyer.

Examples of a structured form that can be displayed in region 302 is a request for information (RFI), a request for a quote (RFQ), and a purchase order (PO). Examples of field names on a structured procurement form include part name, part description, part number, picture of the part, company contact information, and a description of a buyer's requirements with respect to a desired product.

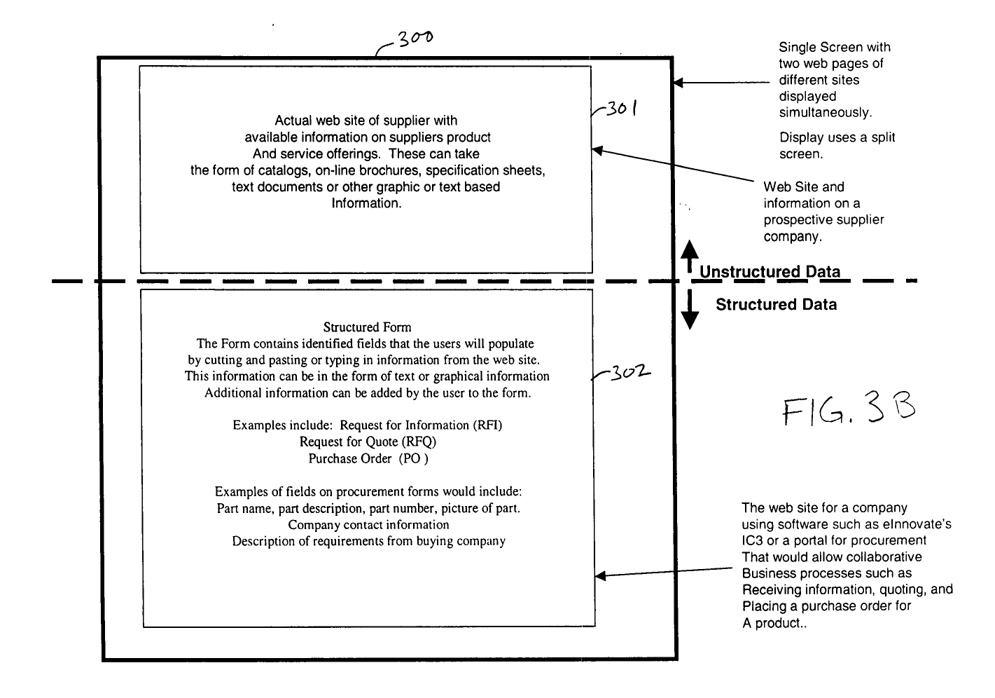

FIG. 4 illustrates a more specific example of converting unstructured information into structured information per step 103. FIG. 4 illustrates a display screen that includes examples of regions 301 and regions 302. In region 301, a supplier's web site is displayed. The supplier's web site displays various products that the supplier has for sale. An Internet portal of the present invention displays region 301 along side a structured form in region 302. The structured form in region 302 of FIG. 4 is an RFI. The structured form includes various fields that the buyer can fill in, such as an item name in region 401, a part number in region 402, a description in region 403, a request for information in region 404, and a due date in region 405.

When the buyer selects Update option 406, the data in fields 401-405 are stored in a database maintained by the Internet portal of the present invention. A buyer can enter data for a second item into fields 401-405 by selecting option 407. A buyer can also attach an unstructured document (such as a word or .pdf document) to form 302 by selecting option 408. The attachment can be, for example, specifications relating to a product that the buyer wants custom built.

A buyer can also enter contact information for a supplier into form 302 (such an email address of a contact person), if the Internet portal does not already have this information stored in its database. Form 302 can also be an RFQ or PO. In these embodiments, form 302 can include fields for a requested price, quantity, delivery schedule, shipment information, etc.

The present invention can then send an email to a contact person at the supplier identified in form 302. The email notifies the supplier that a potential customer has requested information regarding one its products or services. The email requests that the supplier login to the Internet portal's web site to receive more detailed information. The supplier visits a web portal of the present invention to obtain an account login name and a password. The supplier can then login into through the web portal to discover the potential buyer's identity, the product/service the buyer is interested in, and requested information from region 404.

The Internet portal of the present invention provides the supplier with a structured form to respond to the buyer's request for information, request for quote, or purchase order. The supplier can enter a price quote, proposed delivery dates, more detailed information about a product, etc. into the structured form.

The supplier can change data entered by the buyer in particular fields. For example, the supplier can delete a price entered by the buyer and enter a different price. A supplier can also delete a delivery date entered by the buyer and enter a different delivery date. Thus, the present invention allows a buyer to negotiate with a supplier regarding terms of a purchase such as price, delivery dates, quantity, etc.

When the supplier is finished entering data into the form, the data is stored in the database and made available to the buyer for viewing. The buyer can, for example, be notified by email that the supplier has responded to his RFI, RFQ, or PO.

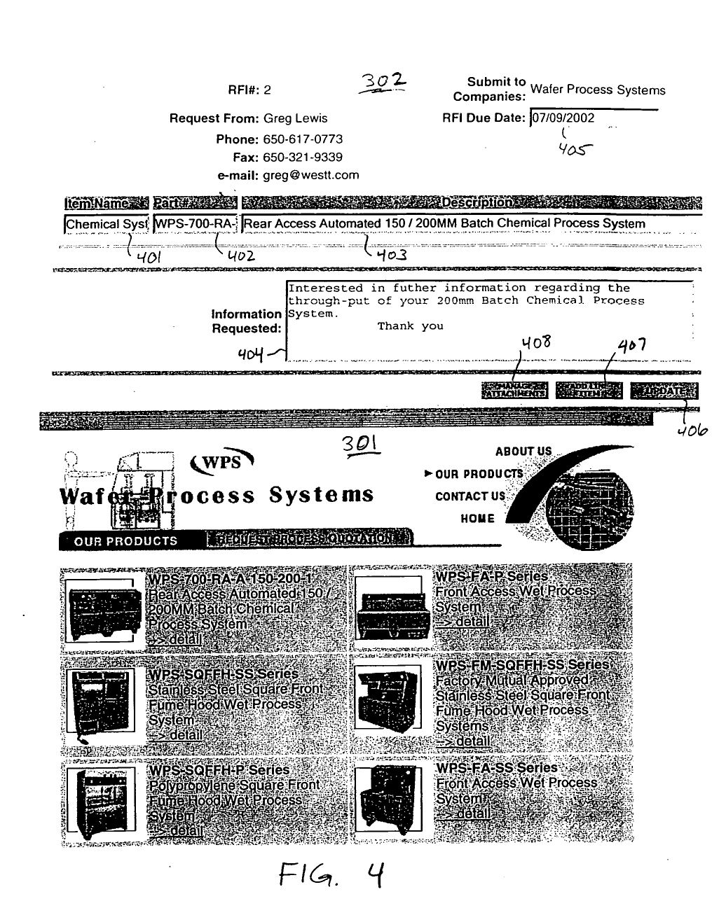

Another structured form is then presented to the buyer to respond back to the supplier. The buyer can change data entered by the supplier and enter new data to continue the negotiation process. Collaborative negotiations continue in this manner until a final agreement is reached between the parties. FIG. 5 illustrates an example of a collaborative negotiations process between a buyer and a supplier according to an embodiment of step 104. At step 501 in FIG. 5, a potential buyer searches for information on suppliers as discussed above with respect to FIG. 2.

After the buyer has identified a supplier and navigated to its web site, the buyer can submit a request for information (RFI) regarding one or more products offered by the supplier at step 502, using a structured form as discussed above with respect to FIGS. 3B and 4. The supplier can also respond to the RFI using a structured form.

Once enough information has been received, the buyer can submit a request for a price quote (RFQ) at step 503. The supplier can respond to the RFQ with a price quote. The buyer can submit a purchase order (PO) at step 504. The supplier can confirm the purchase order by responding to the PO. After a purchase contract has been entered into, the present invention allows a buyer and a supplier to renegotiate the purchase contract if any subsequent changes are needed at step 505. The supplier and the buyer can communicate back and forth with each other as many times as needed at each of steps 502-505. Each communication can be conducted using a structured form provided by an Internet portal of the present invention. All of the data submitted through the structured forms is stored in a database and can be accessed by either party.

The present invention provides buyers with several advantages over prior art systems. For example, buyers can conduct structured and unstructured searches for suppliers through one Internet portal, which is more time efficient than using multiple search engines or conducting only unstructured searches. The present invention allow buyers to request detailed information and to get price quotes from multiple suppliers more easily through one Internet portal.

A portal is a gathering of content and related functionality in a unified user environment. Portal software aggregates and presents content and services related to that content. The content can be in the form of documents, applications, web sites, databases, or external sources like new feeds or applications. Portals typically include a range of tools for content oriented tasks such as collaboration, information retrieval, and document or content management. Through the use of modular, flexible interface components (i.e., portlets), they can enable process-level integration that supports workflow, transaction management, and collaborative business processes.

Also, the present invention stores all of the product data in a database. The present invention can allow a buyer to access this data from the database and display it in a spreadsheet format so the buyer can more easily compare supplier's prices, estimate shipment dates, product details, etc. on one screen without having to manually create a spreadsheet. The present invention also provides buyers and sellers with a more secure communication system than standard email. The communication system of the present invention can be structured to focus each party on relevant details to increase the efficiency and speed of the negotiations process.

The present invention is also advantageous, because it links buyers directly to supplier's web sites. Therefore, there is no need to continuously update a database containing the catalogs of products from numerous suppliers. In the present invention, buyers are always able to obtain the most up-to-date information regarding products that is available on a supplier's own web site.

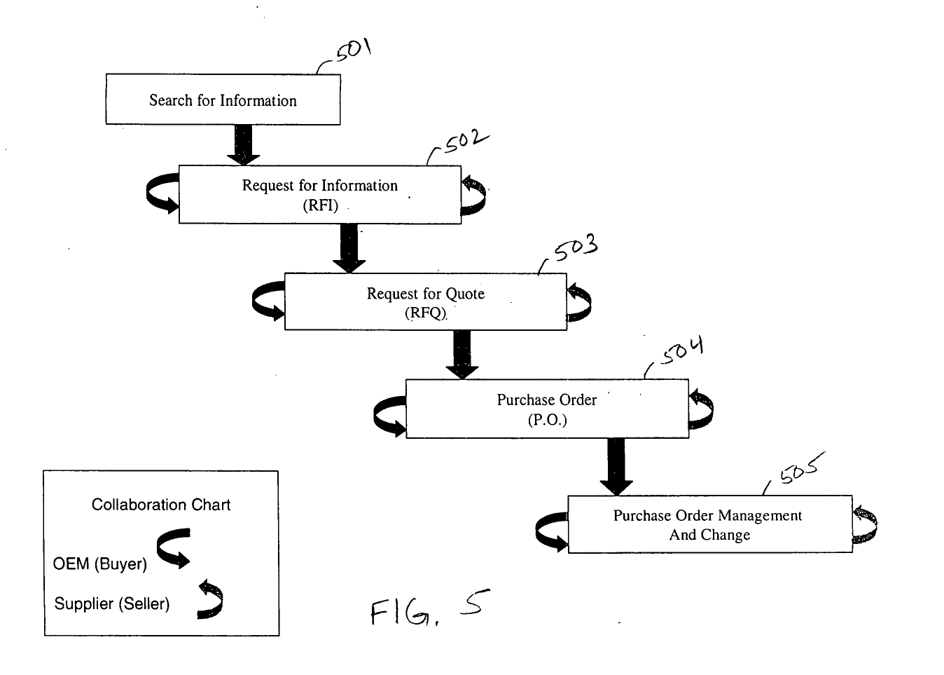

FIG. 6 illustrates a more specific example of a collaborative negotiations process of the present invention. In step 611, a buyer prepares an RFQ using a structured form provided by a portal of the present invention. In this example, the RFQ is not directed to a particular supplier. At step 612, the buyer selects one or more suppliers from search results obtained in searches 111-112 (and/or from searches 113-115). The buyer then sends the RFQ to the selected suppliers at step 613. The suppliers and the buyer exchange information and answer questions at step 614 by communicating back and forth through the Internet portal.

The suppliers create and post price quotes at step 615 using structured forms. The buyer can send an RFQ to one or more of the suppliers. The buyer can negotiate price and other terms with each of the selected suppliers at step 616 by transmitting data through the Internet portal. The buyer and a supplier can change data entered into fields such as price, quantity, and a delivery date, until all the relevant terms are agreed upon.

All data exchanged through the structured forms is stored in the database and organized into a report for comparison by the buyer. The present invention displays the report for the buyer's analysis in step 617. The price quotes from each supplier are displayed in the report. The report can be, for example, in the form of a spreadsheet (or any other suitable format).

After reviewing the report displayed in step 617, the buyer selects the most suitable supplier at step 618 and creates a purchase order for a desired product/service using a structured form. The purchase order is approved at step 619 and sent to the supplier. The supplier is notified of the purchase order at step 620 (e.g., through email) and can login to the Internet portal to accept the purchase order.

In step 621, if the supplier's part is a new part it can be added and saved in a customer specific database. The customer can recall the history of this part in the future. The present invention can create an interactive PO for a product at step 622 that allows a buyer to enter more details about the part. The buyer can also provide detailed specifications regarding a custom part to a supplier as an attachment.

The present invention can interface directly with a buyer's and a supplier's materials resource planning (MRP) software system. MRP systems are well-known to those of skill in the art. For example, details of a potential purchase order (e.g., price, quantity, shipment dates, specifications, etc.) exchanged between a buyer and a seller are downloaded from an Internet portal database of the present invention to the buyer's and the seller's MRP systems.

A seller's MRP system can automatically check available inventory and lead times to estimate dates of delivery. A buyer's MRP system can receive estimated delivery dates for particular parts from suppliers, and can recalculate completion dates for products that require these parts. For example, if a supplier estimates a later than expected delivery date for a constituent part, the buyer's MRP system can recalculate a completion date for the buyer's product that requires the part, and can attempt to push out delivery dates for other constituent parts for that product to reduce inventory and costs associated with storing parts.

The supplier's MRP system can interface directly with the Internet portal of the present invention to automatically respond to RFQs and POs. Human interaction can be limited to approvals of RFQs or POs. A buyer's MRP system can also interface directly with the Internet portal of the present invention to receive and store price, delivery, and other product data sent by the supplier. The buyer's MRP system can respond back to the supplier's MRP system with alternative delivery dates, split delivery dates, or other order modifications.

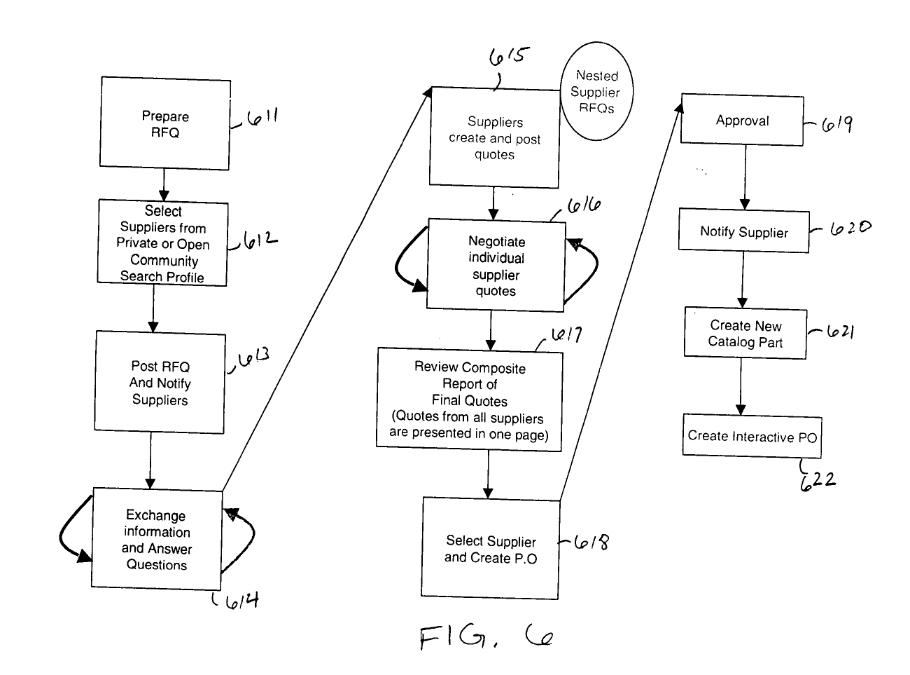

FIG. 7 illustrates an example of a process for negotiating between a buyer (e.g., an OEM) and a seller/supplier using an MRP system. Initially, the buyer searches for a product/service at step 711. The buyer can create (step 712) and prepare (step 713) a requisition using its MRP system. The requisition can include a date, quantity, title, and a purchase order number. The buyer approves the requisition at step 714 (human intervention). The supplier is notified of the order at step 715. The buyer and the supplier negotiate the purchase order details including dates, quantities, price, and additional fees using their respective MRP systems at step 716. At step 717, the buyer and the supplier approve the details of a final PO. Human intervention is typically required for approvals. The buyer's MRP places the purchased product as an item-in-fulfillment at step 718. The supplier ships the item at step 719. The MRP system closes the PO at step 720. Interactive customer service can be performed at step 721.

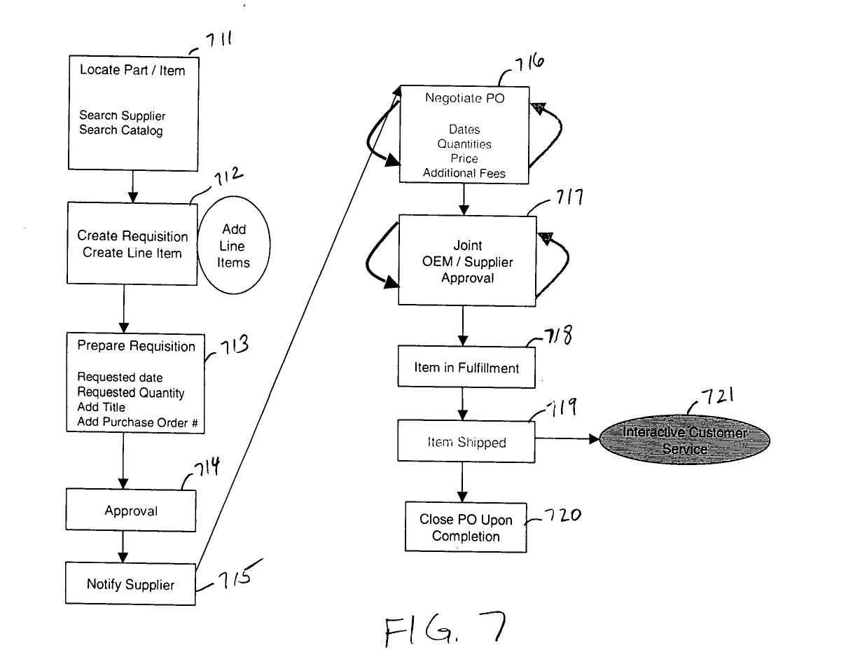

FIG. 8 is a chart that illustrates how buyer and a supplier enter data into fields of structured forms according to the present invention. Initially, an electronic structured form is displayed on the buyer's computer. The structured form has several blank field (e.g., 10). The buyer can enter data about a product or service from the supplier's web site into the electronic form. For example, the buyer enters data from 3 of the 10 fields, such as a product name, quantity, and product number.

A structured form is then displayed to the supplier, which contains the data entered by the buyer for the 3 fields. The supplier can enter data into the structured form about the product or service in response to the buyer's data. For example, the supplier can enter data for 4 of the 10 fields, such as a price, quantity available, ship date, and delivery method. The supplier can also change data in a field that the buyer entered data into. For example, if the buyer entered data into a price field, the supplier can respond by deleting the buyer's price and entering a different price into the price field.

Subsequently, a structured form is displayed to the buyer, which contains the data previously entered by the supplier and the buyer. The buyer can enter additional data into the structured form. For example, the buyer can enter data for the 3 remaining fields. A structured form is then displayed to the suppliers, which contains data for all 10 fields.

The chart shown in FIG. 8 illustrates merely one example of data exchange between a buyer and a supplier. Structured forms of the present invention can include any number of fields. Also, there can be any number of data exchanges between a buyer and a supplier before a transaction is completed.

According to further embodiments of the present invention, different data can be presented to a buyer and a supplier in the structured forms. For example, a structured form can have field for a transaction ID number that is presented to the buyer, but not to the supplier (or visa-versa).

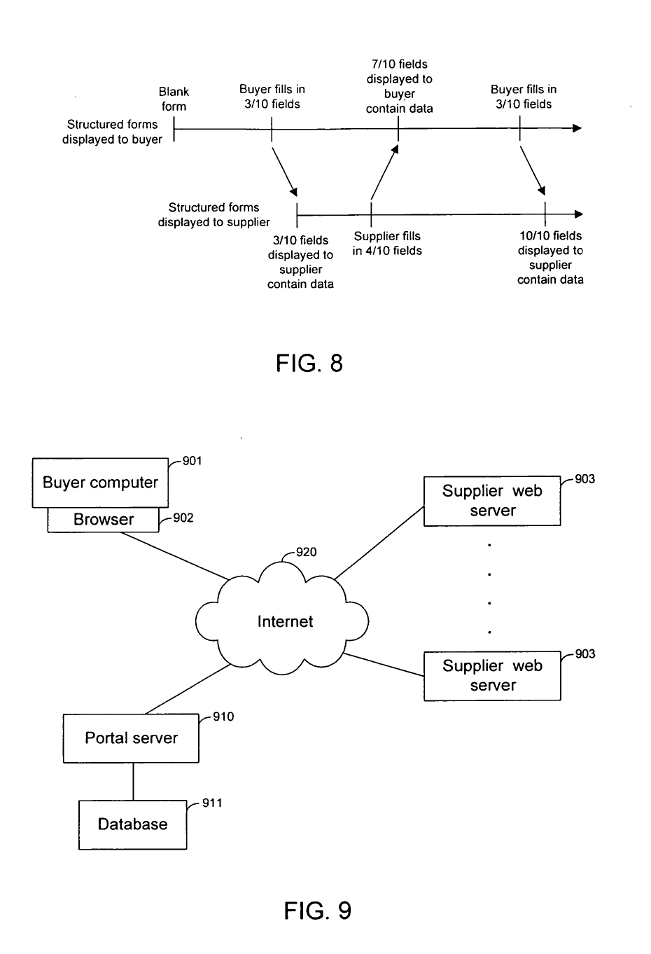

FIG. 9 is a diagram of a system that can implement embodiments of the present invention. A buyer can search for supplier and entered data through a structured form using buyer computer 901, which runs web browser 902. Buyer computer 901 can be, for example, a desktop, a laptop, or a handheld device. Browser 902 displays web sites from suppliers selected by the buyer. The supplier web sites are stored at supplier web servers 903.

Buyer computer 901 communicates with portal server 910 through the Internet 920. Portal server 910 connects to the web servers 903 of suppliers located in the supplier search through Internet 920. Portal server 910 stores data entered by buyers and suppliers into the structured forms into database 911.

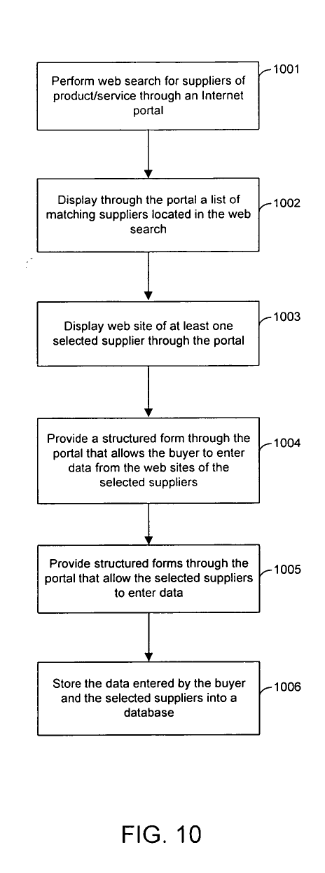

FIG. 10 illustrates another process for locating and collaborating with suppliers according to an embodiment of the present invention. At step 1001, a web search is performed for suppliers of a product or service through an Internet portal of the present invention. At step 1002, a list of matching suppliers located in the web search is displayed to the buyer through the portal. At step 1003, a web site of at least one supplier selected by the buyer from the list of matching suppliers is displayed through the portal to the buyer.

At step 1004, a structured form is provided through the portal that allows the buyer to enter data from the web site of the selected supplier. At step 1005, a structured form is provided through the portal that allows the selected supplier to enter data. At step 1006, the data entered by the buyer and the selected supplier into the structured forms is entered into a database.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

1. A method for conducting purchase transactions between a buyer and a set of suppliers through a portal over the Internet, the method comprising:
performing a web search for suppliers of a product or service through the portal;
displaying, through the portal, a list of matching suppliers located in the web search;
displaying, through the portal, web sites of suppliers selected by the buyer from the list of matching suppliers;
providing, through the portal, a structured form that allows the buyer to enter data from the web sites of the selected suppliers;
providing, through the portal, structured forms that allow the selected suppliers to enter data; and
storing the data entered into the structured forms by the buyer and the selected suppliers in the database.

2. The method of claim 1 wherein the structured forms allow the selected suppliers to change the data entered by the buyer.

3. The method of claim 2 further comprising:
transmitting notification messages to the selected suppliers;
displaying the data entered by the buyer to the selected suppliers;
displaying the data entered by the selected suppliers to the buyer;
displaying a structured form that allows the buyer to enter data in response to the data entered by one of the selected suppliers; and
storing the data entered by the buyer in response to the data entered by the one selected supplier in the database.

4. The method of claim 1 further comprising:
generating a report by analyzing the data stored in the database; and
displaying the report to the buyer.

5. The method of claim 1 wherein the data entered by the buyer includes a request for a price quote, and the data entered by the selected suppliers includes a response to the request for the price quote.

6. The method of claim 1 wherein the data entered by the buyer includes a purchase order.

7. The method of claim 1 wherein performing the search for suppliers further comprises:
searching through a private community of suppliers selected by the buyer.

8. The method of claim 1 wherein performing the search for suppliers further comprises:
searching a directory of suppliers that have been pre-qualified.

9. The method of claim 1 wherein performing the search for suppliers further comprises:
conducting an open search of the Internet using the Internet portal to locate a supplier that matches the search criteria.

10. The method of claim 1 wherein performing the search for suppliers further comprises:
searching through the Internet using search criteria that has been pre-selected to locate suppliers within a specific industry.

11. A computer program product for conducting purchase transactions between a buyer and suppliers through an Internet portal, the computer program product comprising:
code for performing a web search for suppliers using search criteria;
code for displaying, through the Internet portal, a list of suppliers located during the web search that match the search criteria;
code for displaying, through the Internet portal, a web site of a supplier selected by the buyer from the list of suppliers;
code for displaying, through the Internet portal, a structured form that allows the buyer to enter data displayed on the web site of the selected supplier;
code for displaying, through the Internet portal, a structured form that allows the selected supplier to enter data in response to data entered by the buyer;
code for storing the data entered by the buyer and the selected supplier in a database; and
a computer readable medium for storing the codes.

12. The computer program product according to claim 11 wherein the code for displaying the web site of the selected supplier simultaneously displays the web site with the structured form on a display screen to the buyer.

13. The computer program product according to claim 11 further comprising:
code for transmitting notification messages to the selected supplier;
code for displaying the data entered by the buyer to the selected supplier; and
code for displaying the data entered by the selected supplier to the buyer.

14. The computer program product according to claim 13 further comprising:
code for displaying, through the Internet portal, a structured form that allows the buyer to enter data responsive to the data entered by the selected supplier;
code for storing the data entered by the buyer in the database; and
code for displaying the data entered by the buyer to the selected supplier.

15. The computer program product according to claim 11 wherein the structured form allows the selected supplier to enter price data, which is stored in the database; and
the computer program product further comprises code for generating a report based on the price data entered by a plurality of suppliers.

16. The computer program product according to claim 11 wherein the code for performing the search for suppliers using the search criteria further comprises code for performing a structured search through a private community of suppliers selected by the buyer.

17. The computer program product according to claim 11 wherein the code for performing the search for suppliers using the search criteria further comprises searching a directory of pre-qualified suppliers.

18. The computer program product according to claim 11 wherein the code for performing the search for suppliers using the search criteria further comprises conducting an unstructured search of the Internet using the search criteria.

19. The computer program product according to claim 11 further comprising:
code for transmitting a purchase order from the buyer to an MRP system of the selected supplier; and
code for transmitting a delivery date and a price from the selected supplier's MRP system to an MRP system of the buyer.

20. The computer program product according to claim 11 further comprising:
code for displaying a buyer's request for a price quote to the selected supplier; and
code for displaying a price entered by the selected supplier into the structured form to the buyer.
